(19) United States
(12) Patent Application Publication
(10) Pub. No.: US 2012/0303140 A1
(43) Pub. Date: Nov. 29, 2012

(54) METHOD AND APPARATUS FOR USING CUSTOMIZED APPLICATIONS TO OPERATE A HOUSEHOLD APPLIANCE

(76) Inventors: Patrick Ryan Cox, Louisville, KY (US); David Lepie, Louisville, KY (US); Timothy Andrew Gillespie, Louisville, KY (US)

(21) Appl. No.: 13/117,501

(22) Filed: May 27, 2011

(51) Int. Cl. G05B 15/02

(52) U.S. Cl. 700/17

(57) ABSTRACT

An apparatus includes at least one functional device configured to perform at least one specified task, and a controller operatively coupled to the at least one functional device and communicatively coupled to a remote server via a network. The controller is configured to control display of a human machine interface (HMI) via a display device, receive a user input via the HMI to identify a desired application, initiate direct communication with the remote server via the network, and, in response to the initiated communication, to receive data files associated with the identified application from the remote server via the network in response to the user input, wherein the data files include predetermined operation settings associated with the at least one specified task associated with the identified application.

### BACKGROUND OF THE INVENTION

1. Field of the Invention

The embodiments described herein relate generally to household appliances and, more particularly, to downloading and using applications to automatically operate a household appliance.

2. Description of Related Art

At least some known household appliances include liquid crystal display (LCD) screens for receiving user inputs rather than keypads or buttons. However, such known LCD screens do not provide any functionality via an LCD screen that is not offered via keypads or buttons. Moreover, at least some known appliances are capable of connecting to a server to obtain new firmware or to facilitate setting common operation settings within the appliance. However, such known appliances do not enable a user to connect to a remote server to identify a desired new functionality or set of functionalities, and to download those new functionality or set of functionalities directly to the appliance.

### BRIEF SUMMARY OF THE INVENTION

In one aspect, a method of operating a household appliance includes receiving a user input via a human machine interface (HMI) to identify a desired application, initiating direct communication, by a controller, with a remote server via a network, and, in response to the initiated communication, receiving data files associated with the identified application from the remote server via the network in response to the user input, wherein the data files include predetermined operation settings associated with at least one specified task associated with the identified application.

In another aspect, an apparatus includes at least one functional device configured to perform at least one specified task, and a controller operatively coupled to the at least one functional device and communicatively coupled to a remote server via a network. The controller is configured to control display of a human machine interface (HMI) via a display device, receive a user input via the HMI to identify a desired application, initiate direct communication with the remote server via the network, and, in response to the initiated communication, to receive data files associated with the identified application from the remote server via the network in response to the user input, wherein the data files include predetermined operation settings associated with the at least one specified task associated with the identified application.

In another aspect, a controller is provided for use with a household appliance that includes a human machine interface (HMI) and at least one functional device configured to perform at least one specified task. The controller is coupled to a remote server via a network, and includes a memory area configured to store data files associated with at least one application, wherein the data files include predetermined operation settings, instructions, and/or tips associated with the at least one specified task. The controller also includes a processor coupled to the memory area and configured to initiate communication with the remote server via the network, receive a user input via the HMI, receive a listing of applications available for download from the remote server via the network, in response to the user input, and receive data files associated with an application identified by the user directly from the remote server via the network.

### BRIEF DESCRIPTION OF THE SEVERAL VIEWS OF THE DRAWINGS

FIGS. 1-4 illustrate exemplary embodiments of the methods and apparatus described herein.

FIG. 1 is a schematic block diagram of an exemplary system for use in distributing applications to consumers for use with household appliances.

FIG. 2 is a schematic block diagram of an exemplary electrical architecture of a household appliance that may be used with the system shown in FIG. 1.

FIG. 3 is a schematic diagram of an exemplary HMI that enables a user of the household appliance shown in FIGS. 1 and 2 to download customized applications from a server system.

FIG. 4 is a flowchart that illustrates an exemplary method of operating a household appliance.

### DETAILED DESCRIPTION OF THE INVENTION

Exemplary embodiments of methods and apparatus for use in operating a household appliance via customized, downloadable applications are described herein. The described embodiments facilitate managing a plurality of applications and communicating with existing functional devices within the household appliance via a human machine interface (HMI) that is graphical. For example, the HMI provides an interface for a user to select and download applications to a household appliance from a remote server to add new or modified functionality to the household appliance. The methods and apparatus described herein provide benefits to consumers and product manufacturers alike. For example, consumers are provided with a marketplace from which to download new applications that automatically control the household appliance to obtain a desired end. Enabling consumers to add new functionalities to an existing household appliance via a network-connected HMI facilitates extending the useful life of the household appliance for the consumer and/or enables the consumer to customize the appliance per the consumer's preferences. More specifically, the consumer no longer needs to replace a household appliance when the factory-provided functionalities are out of date. Rather, the consumer can simply select new functionalities provided by applications that are available for download via a network.

In some embodiments, the product manufacturer may also provide software or firmware patches in the same mode of distribution. Furthermore, the described embodiments facilitate gathering of market research. For example, a centrally located server can track the downloads of a selected number of consumers to see if minor changes to the control algorithms are received well or not, and then decide to make a full upgrade or “roll-back” those that were researched.

To facilitate understanding of the embodiments described herein, certain terms are defined below. The examples provided herein are exemplary only, and thus are not intended to limit in any way the definition and/or meaning of the below terms.

As used herein, the term “household appliance” or “appliance” refers generally to any device that is used to perform one or more tasks. Exemplary appliances include, but are not limited to, clothing washers and/or dryers, refrigerators, freezers, ranges, ovens, microwave ovens, dishwashers, central vacuums, air conditioners, air purifiers and/or humidifiers, and/or fitness equipment.

As used herein, the term “function” refers generally to basic appliance functionalities such as those that are factory-installed without programming. Conversely, as used herein, the term “application” refers generally to appliance functionalities that enable an appliance to perform one or more functions without additional user inputs. As such, an application is used to perform a function. Exemplary functions include, but are not limited to, operating a baking element or a broiling element to heat a cooking area to a preselected temperature and to maintain the preselected temperature; performing a predetermined wash cycle for clothing or for dishes and cutlery; operating a microwave oven to perform a time-based defrost cycle or a time-based cooking cycle; and the like. Exemplary applications include, but are not limited to, software and/or hardware that includes a computer program or a group of computer programs, such as graphics, word processing, spreadsheets, communications, and/or databases, designed for end users and configured to perform at least one function.

As used herein, the term “functional device” refers generally to a component of an appliance that is used to perform a function. Exemplary functional devices include, but are not limited to, oven bake elements and/or broil elements, gas or electric range burners and/or heating elements, clothing washer actuators, clothing dryer motors, dishwasher water and/or soap dispensers, microwave heating elements, and the like.

As used herein, the term “task” or “specified task” refers generally to an end result as defined by a function or an application. For example, an exemplary task associated with a function is to obtain and maintain an oven cavity at a specified temperature. However, an exemplary task associated with an application may include multiple steps or operations, such as setting a timer, initiating a heating element to obtain a specified temperature within an oven cavity, and prompting a user to insert a product into the oven cavity when the specified temperature is obtained.

Exemplary technical effects of methods and apparatus described herein include at least one of: (a) displaying basic appliance functions and customized appliance applications via a human machine interface (HMI); (b) receiving a user input to initiate either a function or an application; (c) initiating the function when the input relates to the function, and manually operating the appliance according to user controls; (d) when the input relates to a marketplace application, initiating communication between a server system and the appliance, receiving data files from the server system and associated with a selected application, and installing the selected application on the appliance; and (e) when the input relates to a previously stored application, initiating the selected application, automatically adjusting operation settings of the appliance, and automatically operating the appliance to complete a specified task based on the application.

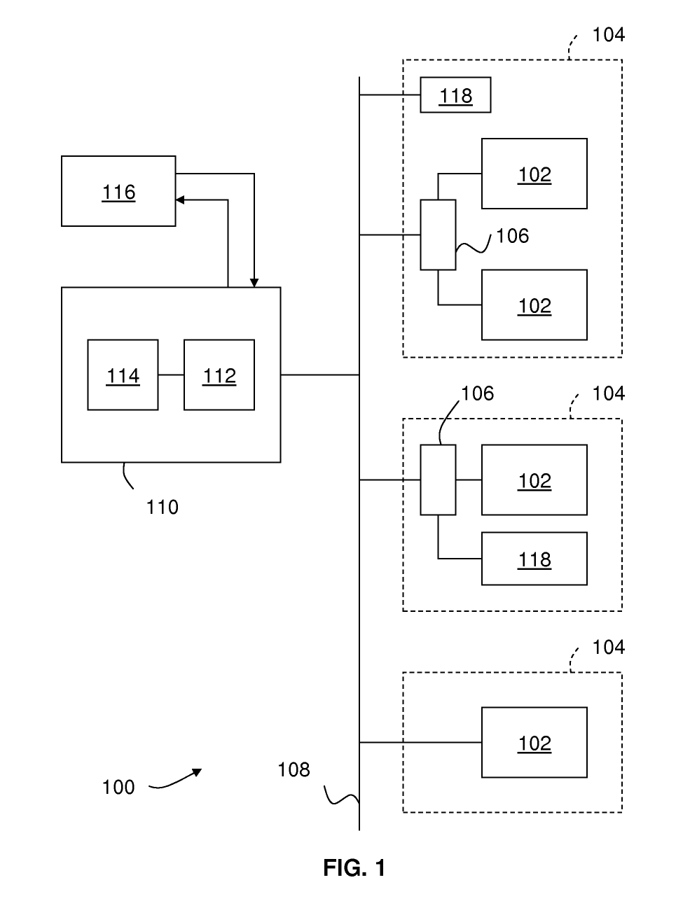

FIG. 1 is a schematic block diagram of an exemplary system 100 for use in distributing applications to household appliances 102. In the exemplary embodiment of FIG. 1, system 100 includes one or more user locations 104 in which appliances 102 are installed. It should be understood that user locations 104 may be homes or businesses. Each user location 104 includes a network device 106 that connects appliances 102 to a network 108, such as the Internet or an intranet. Exemplary network devices 106 include, but are not limited to, a modem, a router, a wireless access point, and/or any other suitable device that enables appliance 102 to communicate via network 108. In some embodiments, appliances 102 are capable of communicating directly with network 108 without the aid of network device 106. For example, appliance 102 may include a controller or processor (not shown) that enables appliance 102 to receive messages from network 108 using, for example, a TCP/IP stack. Alternatively, appliance 102 may include a wireless communication device (not shown) that enables appliance 102 to communicate with a wireless network, such as a cellular network.

In addition, system 100 includes a remote computer or server system 110 that is remotely located from user locations 104 and communicates with network device 106 at each user location 104. Server system 110 includes at least one processor 112, such as a microprocessor, a microcontroller-based platform, a suitable integrated circuit or one or more application-specific integrated circuits (ASICs). Processor 112 is communicably coupled with or operable to access or to exchange signals with at least one data storage or memory area 114, which stores program code and instructions, executable by processor 112, to control server system 110. Memory area 114 also stores other data such data files related to applications available for download to appliances 102 and/or user information, such as contact information and/or billing information. Memory area 114 may include one, or more than one, forms of memory. For example, memory area 114 can include random access memory (RAM), which can include non-volatile RAM (NVRAM), magnetic RAM (MRAM), ferroelectric RAM (FeRAM) and other forms of memory. Memory area 114 may also include read only memory (ROM), flash memory and/or Electrically Erasable Programmable Read Only Memory (EEPROM). Any other suitable magnetic, optical and/or semiconductor memory, by itself or in combination with other forms of memory, may be included in memory area 114. Memory area 114 may also be, or include, a detachable or removable memory, including, but not limited to, a suitable cartridge, disk, CD ROM, DVD or USB memory.

In some embodiments, server system 110 is coupled to a secondary memory area 116, which is capable of storing information on a variety of matters, such as data files related to applications available for download to appliances 102 and/or user information, such as contact information and/or billing information. In one embodiment, secondary memory area 116 is centralized and is stored on server system 110. In an alternative embodiment, secondary memory area 116 is stored remotely from server system 110 and may be non-centralized. Moreover, similar to memory area 114, secondary memory area 116 may include one, or more than one, forms of memory. For example, secondary memory area 116 can include random access memory (RAM), which can include non-volatile RAM (NVRAM), magnetic RAM (MRAM), ferroelectric RAM (FeRAM) and other forms of memory. Secondary memory area 116 may also include read only memory (ROM), flash memory and/or Electrically Erasable Programmable Read Only Memory (EEPROM). Any other suitable magnetic, optical and/or semiconductor memory, by itself or in combination with other forms of memory, may be included in secondary memory area 116. Secondary memory area 116 may also be, or include, a detachable or removable memory, including, but not limited to, a suitable cartridge, disk, CD ROM, DVD or USB memory.

Furthermore, in some embodiments, user location 104 includes a communication device 118 that enables user communication with server system 110 via network 108. Exemplary communication devices 118 include computers, smartphones, personal digital assistants (PDAs), or any other suitable device. Accordingly, in some embodiments, communication device 118 is used to communicate with server system 110 and to select a desired application. Server system 110 thereafter initializes communication with appliance 102 and transmits data files associated with the selected application directly to appliance 102, such as via a communication channel different than the communication channel that connects communication device 118 and server system 110.

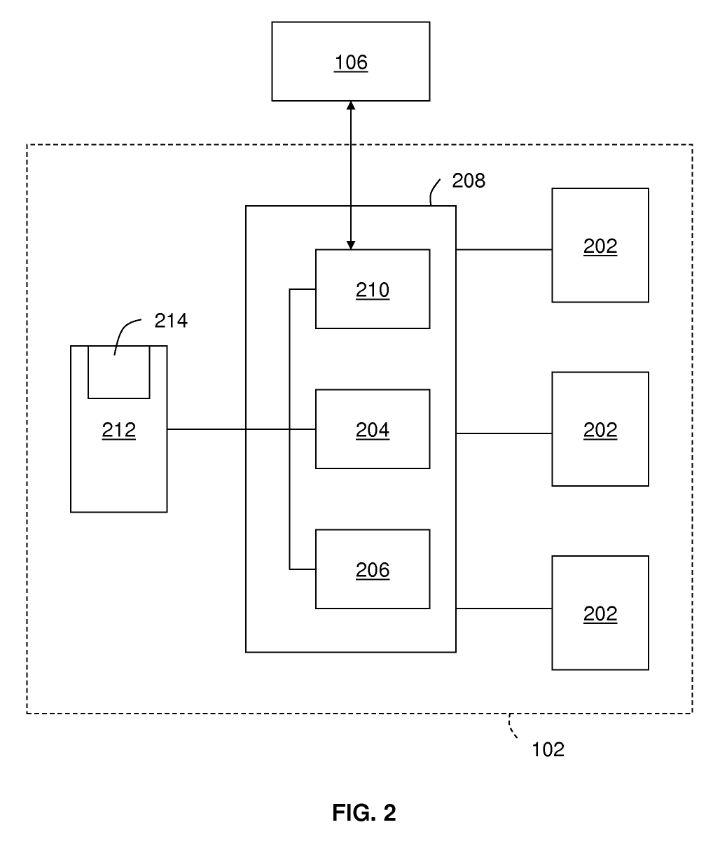

FIG. 2 is a schematic block diagram of an exemplary electrical architecture of household appliance 102. In the exemplary embodiment of FIG. 2, appliance 102 includes one or more functional devices 202. Each functional device 202 is adapted to perform one or more specified tasks. Moreover, appliance 102 includes at least one processor 204, such as a microprocessor, a microcontroller-based platform, a suitable integrated circuit or one or more application-specific integrated circuits (ASICs). Processor 204 is communicably coupled with or operable to access or to exchange signals with at least one data storage or memory area 206. Processor 204 and memory area 206 may be collectively referred to herein as a controller 208.

Memory area 206 also stores other data such data correlations between functional devices 202 and associated specified tasks, and/or data files related to applications for use in operating functional devices 202 to complete the specified task or tasks. Memory area 206 may include one, or more than one, forms of memory. For example, memory area 206 can include random access memory (RAM), which can include non-volatile RAM (NVRAM), magnetic RAM (MRAM), ferroelectric RAM (FeRAM) and other forms of memory. Memory area 206 may also include read only memory (ROM), flash memory and/or Electrically Erasable Programmable Read Only Memory (EEPROM). Any other suitable magnetic, optical and/or semiconductor memory, by itself or in combination with other forms of memory, may be included in memory area 206. In addition, controller 208 includes a network interface 210 that enables appliance 102 to communicate with server system 110 (shown in FIG. 1) via network 108 (shown in FIG. 1) using network device 106. However, in some embodiments, network interface 210 enables appliance 102 to communicate with network 108 without network device 106. For example, appliance 102 may include a controller or processor (not shown) that enables appliance 102 to receive messages from network 108 using, for example, a TCP/IP stack. Alternatively, appliance 102 may include a wireless communication device (not shown) that enables appliance 102 to communicate with a wireless network, such as a cellular network. Moreover, in the exemplary embodiment, network interface 210 communicates with network device 106 using a wireless communication protocol. In an alternative embodiment, network interface 210 communicates with network 108 directly or using network device 106.

Furthermore, household appliance 102 includes a display device 212 that provides a human machine interface (HMI) 214 that enables a user to enter user inputs, such as commands, for use in controlling operation of appliance 102. In some embodiments, display device 212 is a touchscreen device. Accordingly, in some embodiments, display device 212 communicably coupled with or operable to access or to exchange signals with a touchscreen controller (not shown).

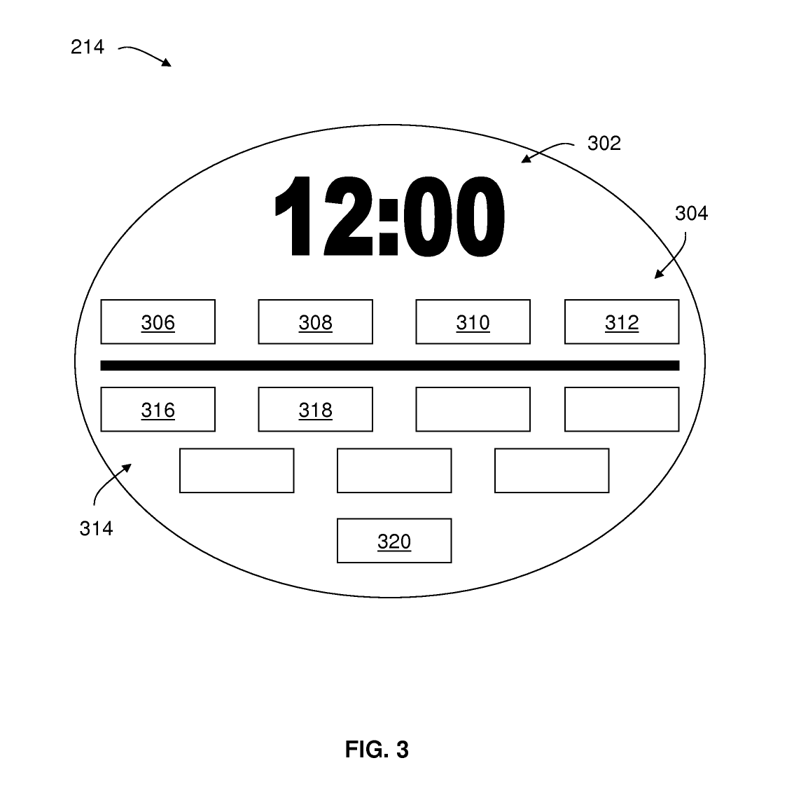

FIG. 3 is a schematic diagram of an exemplary HMI 214 that enables a user of household appliance 102 (shown in FIGS. 1 and 2) to download customized applications from server system 110 (shown in FIG. 1) for use in automatically controlling operation of appliance 102.

In the exemplary embodiment of FIG. 3, HMI 214 includes a clock portion 302 that displays a current time and/or a countdown timer. A user can operate clock portion 302 using input keys (not shown). HMI 214 also includes one or more function keys 304 that are each associated with a basic function of appliance 102. In one embodiment, function keys 304 are graphical icons on a touch screen. Each function key 304 causes controller 208 (shown in FIG. 2) to control one or more functional devices 202 (shown in FIG. 2) within appliance 102 to complete a specified task. For example, where appliance 102 is an oven, a first function key 306 may be associated with a bake function, a second function key 308 may be associated with a broil function, a third function key 310 may be associated with a convection cooking function, and a fourth function key 312 may be associated with a self cleaning function. When a user initiates the bake function by pressing first function key 306, controller 208 activates an associated functional device 202, such as a bake element (not shown). The user then enters a desired baking temperature and/or a desired baking time. Similarly, when a user initiates the broil function by pressing second function key 308, controller 208 activates an associated functional device 202, such as a broil element (not shown). The user then enters a desired broiling time.

In the exemplary embodiment of FIG. 3, HMI 214 also includes one or more application keys 314 that are each associated with a more advanced use of appliance 102, such as predetermined operation settings to complete a specified task. In one embodiment, application keys 314 are graphical icons on a touch screen. Moreover, in one embodiment, the graphical icons associated with application keys 314 and displayed on the touch screen are automatically updated when a new application is downloaded and/or installed. The operation settings can also include cooking instructions and/or tips for display to a user via display device 212. A specified task may use one or more functions associated with function keys 304. However, using application key 314 to initiate an application enables appliance 102 to complete the specified task without additional user inputs.

For example, where appliance 102 is an oven, a first application key 316 may initiate a first application that is associated with a well-known food brand. The first application, e.g., computer-executable instructions that are executed by a processor, such as processor 204 (shown in FIG. 2), when first application key 316 is selected, enables a user to search for a product and, when the user identifies the product, causes controller 208 to operate one or more associated functional devices 202, such as a bake element. For example, first application 316 may cause controller 208 to automatically operate a bake element such that, when the cooking area of appliance 102 reaches a specified temperature, controller 208 prompts the user to position the product in or on the cooking area. Moreover, the first application causes controller 208 to automatically set and monitor a timer based on the identity of the product. Similarly, a second application key 318 may initiate a second application that is associated with a well-known chef or celebrity cook. The second application enables a user to search for a desired meal and, when the user identifies the desired meal, causes controller 208 to display a list of necessary ingredients for use in preparing the desired meal via display device 212. Controller 208 may also display preparation instructions to the user via display device 212. While the user prepares the ingredients, the second application causes controller 208 to automatically operate one or more functional devices 202, such as a bake element and/or a broil element, as described above with respect to the first application. Accordingly, applications associated with application keys 314 eliminate the need for a user to manually operate the timer and/or operational controls of appliance 102 according to a recipe or product instructions.

As another example, and where appliance 102 is a washer, first application key 316 may initiate a first application that is associated with a known clothing manufacturer, clothing label, or designer. The first application, e.g., computer-executable instructions that are executed by processor 204, when first application key 316 is selected, enables a user to search for a product and, when the user identifies the product, causes controller 208 to operate one or more associated functional devices 202, such as a water pump. For example, first application 316 may cause controller 208 to automatically operate the water pump such that, when the current wash cycle of appliance 102 reaches a specified time, controller 208, the first application causes controller 208 to automatically modify a water temperature of water used for the remainder of the wash cycle.

As yet another example, and where appliance 102 is a cooktop, first application key 316 may initiate a first application that is associated with a known food brand. The first application, e.g., computer-executable instructions that are executed by processor 204, when first application key 316 is selected, enables a user to search for a product and, when the user identifies the product, causes controller 208 to operate one or more associated functional devices 202, such as a heating element. For example, first application 316 may cause controller 208 to automatically operate a heating element such that, when the cooking surface of appliance 102 reaches a specified temperature, controller 208 causes appliance 102 to change the temperature setting of the heating element to raise or lower the temperature of the cooking surface. Moreover, the first application causes controller 208 to automatically set and monitor a timer based on the identity of the product.

HMI 214 also includes a marketplace application key 320 that initiates an application that enables a user to select and download additional applications from server system 110 to appliance 102. The marketplace application may enable the user to search for a desired application via, for example, text string searches and/or filtering tools. When the user selects a desired application, appliance 102 initiates a download of the desired application from server system 110 via network 108. Files associated with the download are stored in memory area 206 of appliance 102.

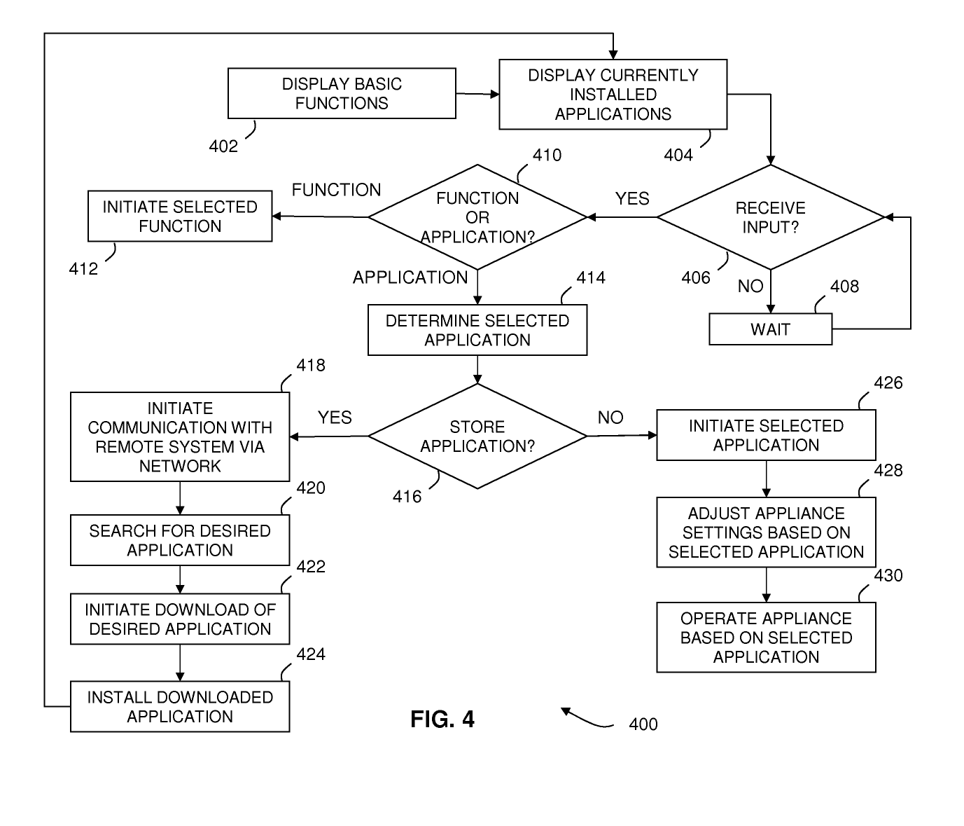

FIG. 4 is a flowchart 400 that illustrates an exemplary method of operating a household appliance, such as household appliance 102 (shown in FIGS. 1 and 2). Initially, HMI 214 (shown in FIGS. 2 and 3) displays 402 one or more function keys 304 (shown in FIG. 3) and displays 404 one or more application keys 314 (shown in FIG. 3) for currently installed applications. In an alternative embodiment, HMI 214 the application keys 314 are advertisements for applications available for download from server system 110 (shown in FIG. 1). Controller 208 (shown in FIG. 2) repeatedly determines 406, such as periodically determines, whether a first user input has been received via HMI 214. If no first user input has been received, controller 208 waits 408 for a specified period of time. When the first user input has been received via HMI 214, controller 208 determines 410 whether the input relates to a function or an application. For example, controller 208 determines 410 whether the first input is a selection of a desired function key 304 or a desired application key 314. In some embodiments, controller 208 determines 410 whether the first input relates to a function or an application according to display coordinates of the first input. For example, each function key 304 and application key 314 is associated with display coordinates on HMI 214 that are stored in memory area 206 (shown in FIG. 2). When controller 208 determines 410 that the first input is a selection of a desired function key 304, controller 208 initiates 412 the selected function and controls one or more functional devices 202 (shown in FIG. 2) within appliance 102 to complete a specified task as described above.

When controller 208 determines 410 that the first input is a selection of a desired application key 314, controller 208 then determines 414 an identity of the selected application. In some embodiments, controller 208 determines the identity of the selected application based on display coordinates of the first input as stored in memory area 206. If controller 208 determines 416 that the desired application is a marketplace application, controller 208 initiates 418 communication with server system 110 via network 108. HMI 214 displays a listing of applications that may be downloaded to appliance 102. The user may search 420 via a text string and/or filter applications or search results to identify a desired application. The user then selects the desired application, and download of the application is initiated 422. For example, appliance 102 receives data files associated with the application, including predetermined operation settings associated with a specified task for completion by appliance 102 using the application. When the application has been received by appliance 102, the application is installed 424. For example, an executable file associated with the application an icon representative of the application are stored in memory area 206 and correlated for use in initiating the application via HMI 214.

In the exemplary embodiment, and when controller 208 determines 416 that the desired application is not the marketplace application, controller 208 initiates 426 the application that was selected by the user. For example, controller 208 determines the identity of the selected application based on display coordinates of the first input as stored in memory area 206, and locates an executable file associated with the application within memory area 206. Controller 208 then executes the executable file. Controller 208 adjusts 428 appliance settings based on the selected application according to the predetermined operation settings stored in memory area 206. Controller 208 then operates 430 appliance 102 according to the predetermined operation settings to complete a specified task. A specified task may use one or more functions associated with function keys 304. However, using application key 314 to initiate an application enables appliance 102 to complete the specified task without additional user inputs.

Exemplary embodiments of methods, systems, and apparatus for operating a household appliance using customized applications are described above in detail. The methods and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A server, controller, or computer, such as those described herein, includes at least one processor or processing unit and a system memory. The server, controller, or computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary application distribution system environment, embodiments of the invention are operational with numerous other general purpose or special purpose application distribution system environments or configurations. The application distribution system environment is not intended to suggest any limitation as to the scope of use or functionality of any aspect of the invention. Moreover, the application distribution system environment should not be interpreted as having any dependency or requirement relating to any one or combination of components illustrated in the exemplary operating environment. Examples of well known application distribution systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of operating a household appliance, said method comprising:
receiving a user input via a human machine interface (HMI) of the household appliance to identify a desired application;
initiating direct communication, by a controller of the household appliance, with a remote server via a network; and
in response to the initiated communication, receiving data files associated with the identified application from the remote server via the network in response to the first user input, the data files including predetermined operation settings associated with at least one specified task associated with the identified application.

2. A method in accordance with claim 1, wherein initiating direct communication with a remote server comprises receiving a listing of applications available for direct download from the remote server to the controller via the network, in response to the user input.

3. A method in accordance with claim 2, further comprising displaying the received listing of applications available for direct download from the remote server.

4. A method in accordance with claim 3, further comprising:
searching through the received listing of applications for the identified application;
receiving a selection of the identified application; and
receiving the data files associated with the identified application from the remote server.

5. A method in accordance with claim 1, further comprising:
displaying at least one function and at least one application via the HMI; and
determining whether the user input relates to the at least one function or the at least one application.

6. A method in accordance with claim 5, wherein when the user input relates to the at least one function, said method further comprises initializing the at least one function.

7. A method in accordance with claim 5, wherein when the user input relates to the at least one application, said method further comprises automatically operating the household appliance based on the predetermined operation settings to complete the at least one specified task.

8. A method in accordance with claim 7, wherein automatically operating the household appliance comprises adjusting operation settings of the household appliance based on the predetermined operation settings associated with the at least one application.

9. An apparatus comprising:
at least one functional device configured to perform at least one specified task; and
a controller operatively coupled to said at least one functional device, said controller communicatively coupled to a remote server via a network and configured to:
control display of a human machine interface (HMI) via a display device;
receive a user input via the HMI to identify a desired application;
initiate direct communication with the remote server via the network; and
in response to the initiated communication, receive data files associated with the identified application from the remote server via the network in response to the user input, the data files including predetermined operation settings associated with the at least one specified task associated with the identified application.

10. An apparatus in accordance with claim 9, wherein said controller is further configured to receive a listing of applications available for direct download from the remote server via the network, in response to the user input, the listing of applications including the identified application.

11. An apparatus in accordance with claim 9, wherein said controller is further configured to cause the HMI to display at least one function and at least one application.

12. An apparatus in accordance with claim 11, wherein said controller is further configured to determine whether the user input relates to the at least one function or the at least one application.

13. An apparatus in accordance with claim 12, wherein, when the user input relates to the at least one function, said controller is further configured to execute the at least one function to cause said at least one functional device to perform the at least one specified task under control of the user via the HMI.

14. An apparatus in accordance with claim 11, wherein, when the user input relates to the at least one application, said controller is further configured to execute the at least one application to automatically cause said at least one functional device to complete the at least one specified task based on the predetermined operation settings.

15. An apparatus in accordance with claim 14, wherein said controller is configured to cause said at least one functional device to complete the at least one specified task by adjusting operation settings of said at least one functional device based on the predetermined operation settings associated with the at least one application.

16. A controller for use with a household appliance that includes a human machine interface (HMI) and at least one functional device configured to perform at least one specified task, said controller configured to be coupled to a remote server via a network, said controller comprising:
a memory area configured to store data files associated with at least one application, the data files including predetermined operation settings associated with the at least one specified task; and
a processor coupled to said memory area and configured to:
initiate communication with the remote server via the network;
receive a user input via the HMI;
receive a listing of applications available for download from the remote server via the network, in response to the user input; and
receive data files associated with an application identified by the user directly from the remote server via the network.

17. A controller in accordance with claim 16, wherein said processor is further configured to cause the HMI to display a first executable icon representative of at least one function and a second executable icon representative of the identified application.

18. A controller in accordance with claim 17, wherein said processor is further configured to execute the at least one function to cause the at least one functional device to perform the at least one specified task under control of the user via the HMI.

19. A controller in accordance with claim 17, wherein said processor is further configured to execute the at least one application to automatically cause the at least one functional device to complete the at least one specified task based on the predetermined operation settings.

20. A controller in accordance with claim 19, wherein said processor is configured to cause the at least one functional device to complete the at least one specified task by adjusting operation settings of the at least one functional device based on the predetermined operation settings associate with the at least one application.
